(19) United States
(12) Patent Application Publication
(10) Pub. No.: US 2010/0058344 A1
(43) Pub. Date: Mar. 4, 2010

(54) ACCELERATING A QUIESCENCE PROCESS OF TRANSACTIONAL MEMORY

(76) Inventors: Yang Ni, Sunnyvale, CA (US); Richard Myungon Yoo, Atlanta, GA (US); Adam Wojciech Welc, San Francisco, CA (US); Bratin Saha, Santa Clara, CA (US); Ali-Reza Adl-Tabatabai, Santa Clara, CA (US)

Correspondence Address: c/o BLAKELY, SOKOLOFF, TAYLOR & ZAFMAN LLP, 1279 Oakmead Parkway, Sunnyvale, CA, 94085-4040, US

(21) Appl. No.: 12/198,820

(22) Filed: Aug. 26, 2008

(51) Int. Cl. G06F 9/46; G06F 17/30; G06F 7/00

(52) U.S. Cl. 718/101; 707/8; 707/E17.007

(57) ABSTRACT

A method to perform validation of a read set of a transaction is presented. In one embodiment, the method compares a read signature of a transaction to a plurality of write signatures associated with a plurality of transactions. The method determines based on the result of comparison, whether to update a local value of the transaction to a commit value of another transaction from the plurality of the transactions.

### FIELD OF THE INVENTION

Embodiments of the invention relate to transactional memory; more particularly, embodiments of methods and systems to improve a quiescence process.

### BACKGROUND OF THE INVENTION

Transactional memory simplifies concurrent programming, which has been challenging but crucial in realizing the performance benefit of multi-core processors. Transactional memory allows a group of load and store instructions to execute in an atomic way. Transactional memory also alleviates those pitfalls of lock-based synchronization.

Software transactional memory (STM) provides transactional memory semantics in a software runtime library and requires minimal or no hardware support. An STM may use read and write barriers for shared memory reads and writes in transactional code sections. The read and write barriers allow the runtime system to maintain metadata that are required for data versioning and conflict detection for STM. For example, a write barrier may be a procedure inserted by programmers, a compiler, a middleware, or a runtime system to process every write operation to a shared resource. The write barrier procedure checks and records the lock state of the shared resource. Additionally, the write barrier identifies any conflict over the shared resource and resolves the conflict in accordance with a predefined protocol.

Privatization happens when a transaction (of a process/thread) removes a shared resource or a portion thereof (e.g. memory space) from public access. A transaction privatizes a shared resource so that a thread can use the shared resource in non-transactional instruction(s) later. Other active transactions may also have the reference to the same shared resource especially in a system where an optimistic read is allowed. An active transaction is a transaction in an executing phase, or is in a commit phase but has not validated its read set (rollback may happen). An active transaction may modify the value/state of a shared resource.

A transaction (of a thread) that privatizes the shared resource should wait for these other transactions which use the same shared resource to finish before the thread starts working on the privatized resource. Otherwise, if the transaction does not wait (and the thread proceeds to execute the non-transactional instructions thereafter) while other transactions are still using the same shared resource, this creates a racing condition and the results of the execution become unpredictable.

For example, a link list has element 1 to element 10 in sequence. Transaction A (of thread A) privatizes elements 2-10 (removing them from public access) by assigning the next-pointer of element 1 to null. Transaction B had read the reference to element 2 before the removal of the link. Thread A will operate on elements 2-10 in the following non-transactional section after transaction A completes. To avoid a racing condition for elements 2-10, thread A should wait for transaction B to finish before operating on the privatized resource (elements 2-10).

A quiescence algorithm can be used to guarantee proper execution of the transactions in a system that provides privatization semantics. In such an algorithm, a committing transaction waits in a quiescence phase until all other active transactions validate that their read sets do not overlap with the committing transaction's write set. After exiting the quiescence phase, the transaction safely terminates. The thread proceeds to execute the instructions following thereafter. In some cases, the waiting time for other active transactions to validate, abort, or commit is significant enough to reduce the performance of a system.

### BRIEF DESCRIPTION OF THE DRAWINGS

Embodiments of the present invention will be understood more fully from the detailed description given below and from the accompanying drawings of various embodiments of the invention, which, however, should not be taken to limit the invention to the specific embodiments, but are for explanation and understanding only.

FIG. 1 is a flow diagram of one embodiment of a transaction execution process.

FIG. 2 shows one embodiment of a data structure associated with a transaction.

FIG. 3 is an embodiment of a read/write signature of a transaction.

FIG. 4 is a flow diagram of one embodiment of a validation process.

FIG. 5 is a flow diagram of one embodiment of a process for a quiescence algorithm.

FIG. 6 is a block diagram of one embodiment of a validation system.

FIG. 7 illustrates a computer system for use with one embodiment of the present invention.

### DETAILED DESCRIPTION OF THE INVENTION

Embodiments of methods and systems to improve a quiescence process of transactions are described. In one embodiment, a transaction performs validation by comparing a read signature of the transaction to published write signatures associated with committing transactions. The transaction determines, based on a result of the comparison, whether to update its local timestamp to a commit timestamp of another transaction selected from the committing transactions. Accordingly, before a transaction terminates/completes properly, the transaction enters a quiescence phase and waits until all local timestamps of other active transactions are greater than or equal to the commit timestamp of the transaction.

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of present invention also relate to apparatuses for performing the operations herein. Some apparatuses may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, DVD-ROMs, and magnetic-optical disks, read-only memories (ROMs), random access memories (RAMs), EPROMs, EEPROMs, NVRAMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, embodiments of the present invention are not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

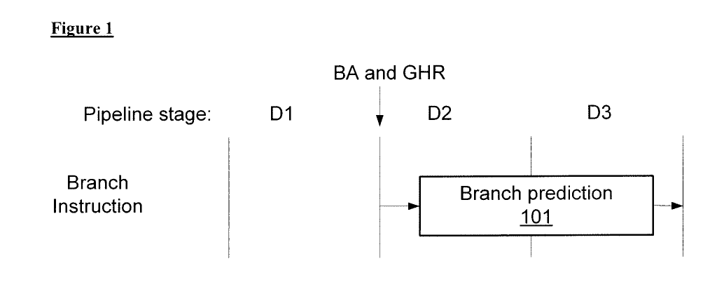

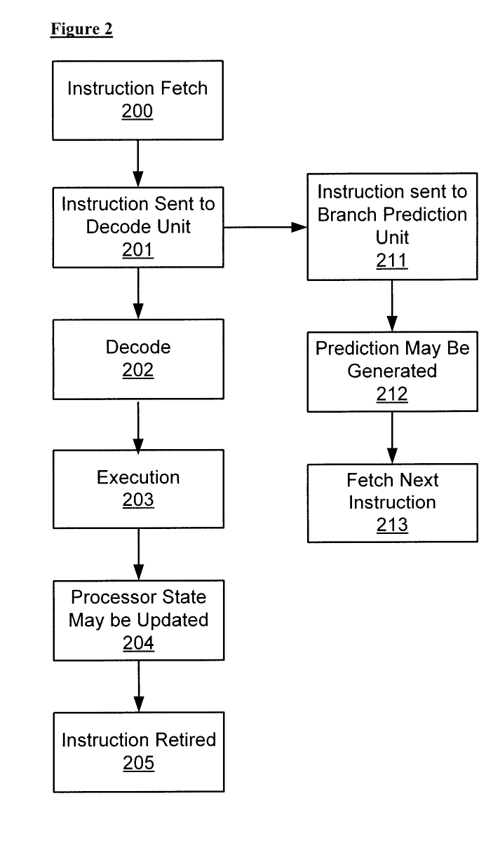

FIG. 1 is a flow diagram of one embodiment of a transaction execution process. Referring to FIG. 1, the process is performed by processing logic that may comprise hardware (circuitry, dedicated logic, etc.), software (such as is run on a general purpose computer system or a dedicated machine), or a combination of both. Referring to FIG. 1, the process begins by initiating a transaction (processing block 100). The processing logic creates a data structure associated with a transaction (processing block 101). The details will be described in further detail below with additional reference to FIG. 2. The processing logic executes the instructions in the atomic section (processing block 102). In one embodiment, the processing logic performs validation for read and write barriers (inserted by compilers or programmers) to determine if the local timestamp of a transaction can be updated to the current global timestamp (processing block 110). The use of these timestamps will be described in further detail below with additional references to the remaining figures.

In one embodiment, in response to a write barrier for a memory store operation within the transaction, the processing logic tries to exclusively lock a shared resource (memory location). If the shared resource is already locked by another transaction, the runtime will try to resolve the conflict before continuing, which may abort the current transaction. If the shared resource is unlocked, the processing logic will: 1) lock the shared resource, 2) record the current value/state of the share resource in an undo log, and 3) add the shared resource to its write set, and then 4) update the shared resource.

In one embodiment, in response to a read barrier for a memory load operation within the transaction, the processing logic checks if the shared resource (memory location) is locked, but does not try to lock it. In one embodiment, the processing logic reads the value in the location if the memory location is not locked for writing by another transaction. The processing logic will 1) read the value in the location, and 2) add the shared resource to the read set.

In one embodiment, a transaction is ready to commit after the instructions therein have completed. The committing transaction enters a commit phase (processing block 120). The committing transaction validates the read set to ensure that no shared resource in the set has been updated after the transaction read them. If the validation succeeds, the committing transaction unlocks all shared resources in its write set. Otherwise, the committing transaction aborts. On the abort of a transaction, the processing logic restores the old values recorded in the undo log by writing back to the corresponding addresses (a rollback operation) and the shared resources in the write set will be unlocked.

In one embodiment, a compiler inserts a write barrier and a read barrier as system calls in response to a memory store operation and a memory load operation. The operating system loads and executes a runtime library when it encounters the system calls. In one embodiment, the programmers designate write barriers and read barriers at locations deemed suitable for maintaining the read set and the write set of the transaction.

In one embodiment, a reader transaction is a transaction that calls one or more read operations from a shared resource, such as, for example, a load operation reading from a memory location. A reader transaction therefore has a read dependency with respect to the shared resource. In one embodiment, a writer transaction is a transaction that calls one or more write/update operations to a shared resource, such as, for example, a store operation writing to a memory location. A writer transaction has a write dependency with respect to the shared resource. In one embodiment, a transaction can be a writer and a reader with respect to a shared resource. In one embodiment, a transaction is a writer, a reader, or a combination thereof with respect to multiple shared resources.

FIG. 2 shows one embodiment of a data structure associated with a transaction. Referring to FIG. 2, in one embodiment, the data structure comprises local timestamp 202, read set 203, write set 204, write signature 206, read signature 205, commit timestamp 207, and undo log 208.

In one embodiment, read set 203 is a list of shared resources that a transaction has accessed. For example, read set 203 contains a set of shared variables or the memory locations thereof which are read during the transaction. In one embodiment, read set 203 is mapped to read signature 205 using a hash function to reduce the number of bits required to represent the shared resources. In one embodiment, read signature 205 is a bloom filter generated using a combination of hash functions. In one embodiment, read signature 205 is N-bit in length and represents a memory map of a transaction (workload of a transaction). The content of read signature 205 indicates sections of the workload that have been read or not by the transaction. In one embodiment, during a read barrier, a hash function maps a memory address to one or more bit locations of read signature 205.

In one embodiment, write set 204 is a list of shared resources to which a transaction has written. For example, write set 204 contains a set of shared variables or memory locations thereof which are speculatively stored-into during the transaction. In one embodiment, a transaction removes a shared resource (during privatization) and the write set of the transaction is updated with the address of the shared resource. In one embodiment, write set 204 is mapped to write signature 206 using a hash function to reduce the number of bits required to represent the shared resources. In one embodiment, write signature 206 is a bloom filter generated with a combination of hash functions. In one embodiment, write signature 206 can be generated from write set 204 using the methods described above with respect to read signature 205. In one embodiment, performing an operation on read signature 205 and write signature 206 is faster than performing a similar operation on read set 203 and write set 204.

In one embodiment, local timestamp 202 indicates the latest timestamp value when the read signature 205 of a transaction is validated against published write signatures of other transactions that are ready to commit.

In one embodiment, when a transaction is ready to commit, the value of a global timestamp (not shown) is increased, commit timestamp 207 of the transaction is updated to the value of the global timestamp. In one embodiment, when a transaction commits or aborts, all tracking information in the data structure is cleared. In one embodiment, if a transaction aborts, information in undo log 208 is used to restore the values/states of shared resources modified by the transaction.

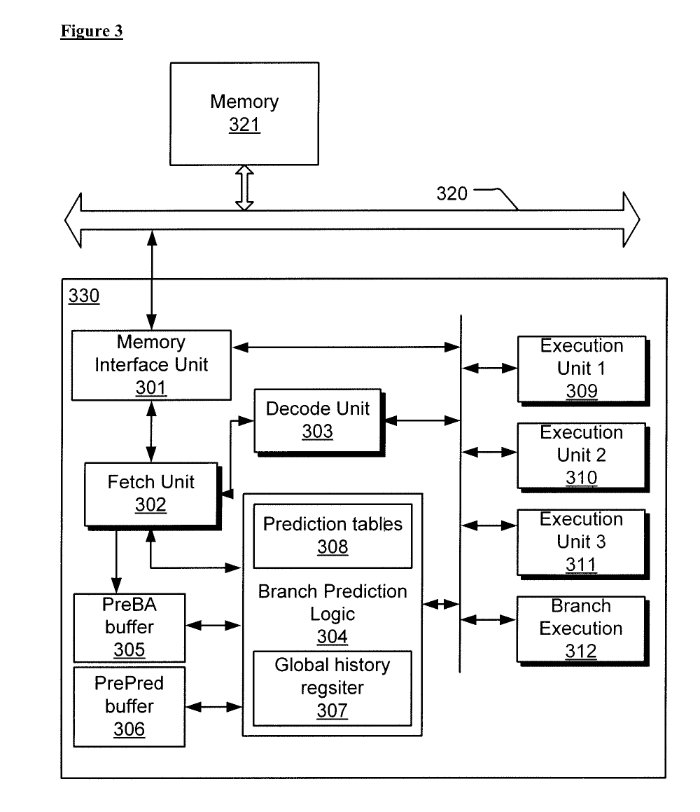

FIG. 3 is an embodiment of a read signature or a write signature of a transaction. In one embodiment, with reference to FIG. 3, signature 320 is a read signature indicating sections of memory locations that have been read by the transaction. Memory resource 310 is logically divided into sections, each section comprising 10 memory locations. For example, section 311 comprises memory location 11-20 and section 312 comprises memory location 91-100. In one embodiment, a hash function maps section 311 (and the memory locations therein) to bit location 321 of signature 320. The content of bit location 321 is ‘0’ indicating that no memory location in section 311 has been read by the transaction. The content of bit location 322 is ‘1’ indicates that at least one of the memory locations in section 312 has been read by the transaction.

In one embodiment, signature 320 may show a false positive indication but may never show a false negative indication. In other words, a memory location may be indicated as ‘read’ based on the value of signature 320 due to other memory location in the same section has been read. Nevertheless, a memory location is never indicated as ‘not-read’ (indicated with a ‘0’ in the signature 320) if it has in fact been accessed by the transaction.

It will be appreciated by those skilled in the art that many hash functions can be adapted to map a read set to a read signature. In one embodiment, the input to a hash function is the first few bits of a memory address, the last few bits of a memory address, or a combination thereof. In one embodiment, a bloom filter in conjunction with a combination of hash functions can be used to map the information in a read set to a read signature. Similarly, a write signature can be generated based on a write set using the methods described above.

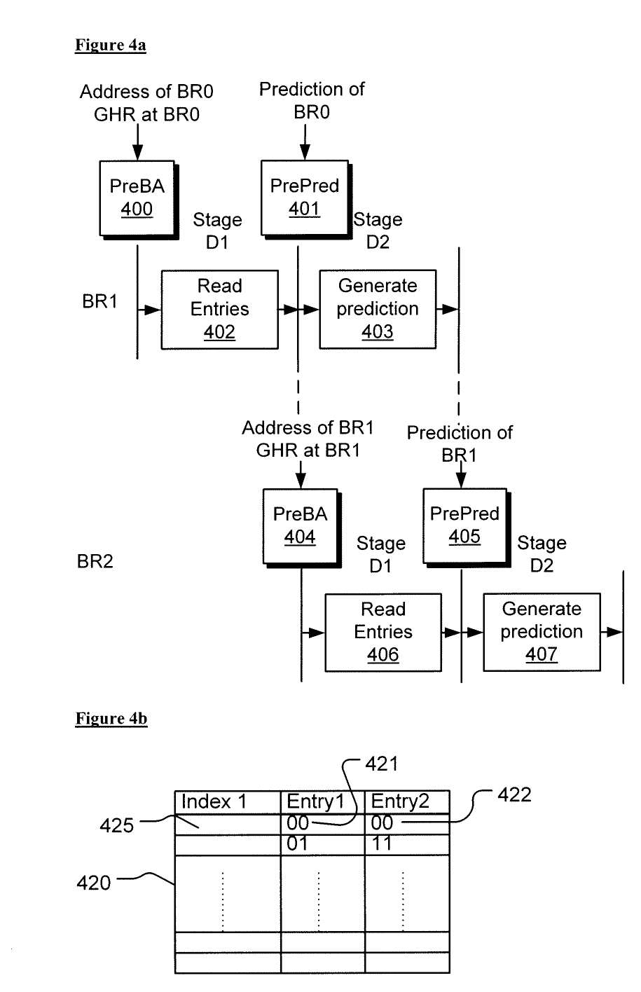

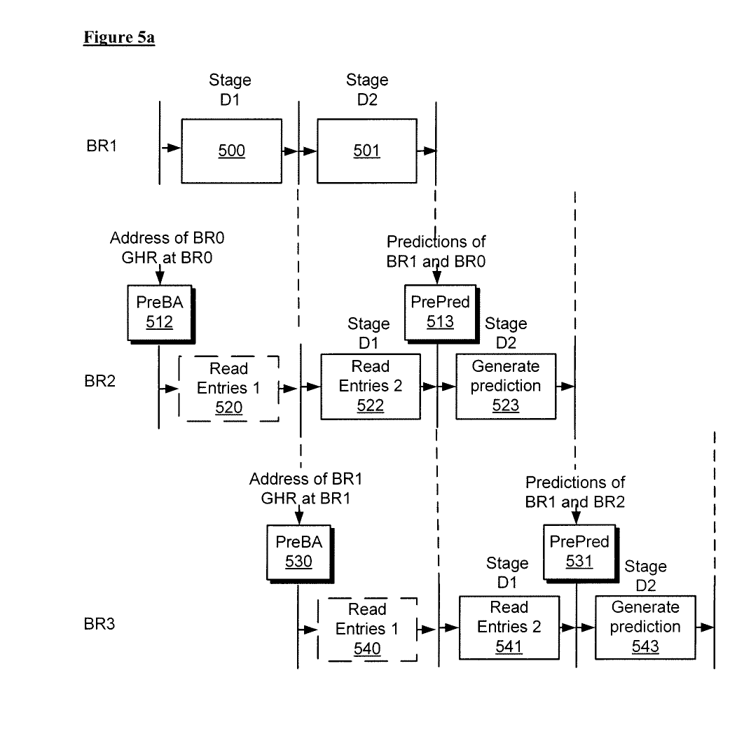

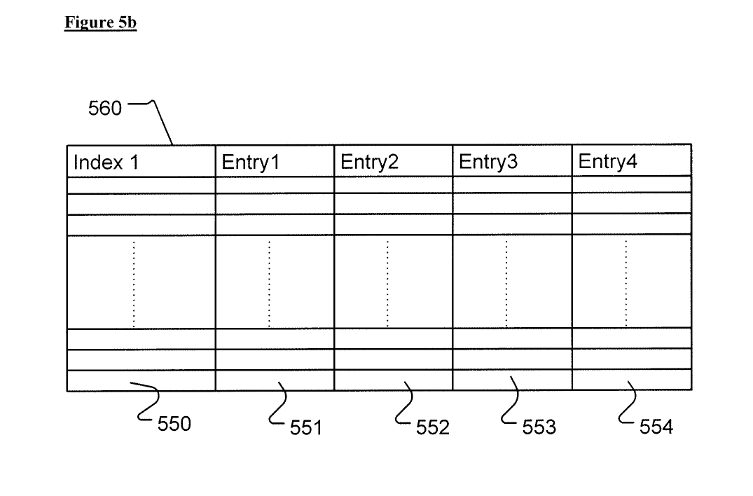

FIG. 4 is a flow diagram of one embodiment of a validation process. Referring to FIG. 4, the process is performed by processing logic that may comprise hardware (circuitry, dedicated logic, etc.), software (such as is run on a general purpose shared system or a dedicated machine), or a combination of both. The processing logic begins a validation process for a current transaction by selecting one of the published write signatures of committing transactions (processing block 402). The processing logic compares the read signature of the current transaction with the selected write signature (processing block 403). In one embodiment, the comparison is an intersecting operation or an “AND” operation. In one embodiment, the intersecting operation is performed using an AND instruction of a processor that operates on 128-bit or 256-bit registers. The processing logic determines whether an intersection between the two signatures exists or not (processing block 410). If an intersection exists, the processing logic records the conflict information (processing block 406). The processing logic continues to perform the comparison to other remaining published write signatures (processing block 411). The processing logic updates the local timestamp of the current transaction based on the conflict information recorded (results of the comparison) (processing block 407).

In one embodiment, the processing logic does not update the local timestamp of the current transaction if any intersection with one of the published write signatures is recorded. The local timestamp is updated to the global timestamp only when no intersection exists with any of the published write signatures.

In one embodiment, the processing logic updates the local timestamp of the current transaction to the highest commit timestamp of a committing transaction, and the commit timestamp is lower than commit timestamps of any other intersecting transactions (transactions with write signatures that intersect with the read signature of the current transaction).

For example, in one embodiment, assuming that 5 transactions (A, B, C, D, E) are in-flight. Transaction A is executing and triggers a validation process. Four others transactions (B, C, D, and E) are committing (or validating). Assuming the facts that:
1) The write signature of transaction B has no intersection with the read signature of transaction A. The commit timestamp of transaction B is 104.
2) The write signature of transaction C has no intersection with the read signature of transaction A. The commit timestamp of transaction C is 101.
3) The write signature of transaction D has at least one intersection with the read signature of transaction A. The commit timestamp of transaction D is 103.
4) The write signature of transaction E has no intersection with the read signature of transaction A. The commit timestamp of transaction E is 102.

In one embodiment, the processing logic updates the local timestamp of transaction A (after the validation process) to the commit timestamp of transaction E (i.e., 102). The commit stamp is the highest commit timestamp that is lower than any commit stamp(s) of intersecting transaction(s) (transaction D is intersecting; the commit timestamp of transaction D is 103). Transaction A cannot update it local timestamp beyond a commit timestamp that is associated with any intersecting transactions.

FIG. 5 is a flow diagram of one embodiment of a process for a quiescence algorithm. Referring to FIG. 5, the process is performed by processing logic that may comprise hardware (circuitry, dedicated logic, etc.), software (such as is run on a general purpose shared system or a dedicated machine), or a combination of both. In one embodiment, a transaction has to commit before it can safely terminate. The processing logic begins by performing validation and dependency checking for the committing transaction, for example, read-set validation which is known in the art (processing block 501). The processing logic increases a global timestamp to a next number (processing block 502). The processing logic assigns the commit timestamp of the committing transaction to the global timestamp.

In one embodiment, the processing logic publishes the commit timestamp and the write signature of the committing transaction (processing block 503). In one embodiment, the processing logic publishes the information by writing the information to a shared memory space that is accessible by other transactions. In one embodiment, the processing logic notifies other transactions when new information is available. In one embodiment, the processing logic sends a message to notify other transactions about the new information.

In one embodiment, the processing logic switches the committing transaction to a quiescence phase (processing block 504). In one embodiment, the committing transaction waits in the quiescence phase until the local timestamps of all active transactions are greater than or equal to the commit timestamp of the committing transaction (processing block 510). The processing logic switches the committing transaction out from the quiescence phase (the transaction exits the quiescence phase) if the condition is met (processing block 505).

In one embodiment, the active transactions do not include the transactions which are committed or aborted. In one embodiment, a committing transaction that has privatized a shared resource only exits a quiescence phase if all other transactions either: 1) do not read the privatized shared resource at all, 2) may have read the private shared resource but are not longer using the resource (transactions have committed or aborted), or 3) may have read the private shared resource but have a greater or equal local timestamp as compared to the commit time stamp of the committing transaction.

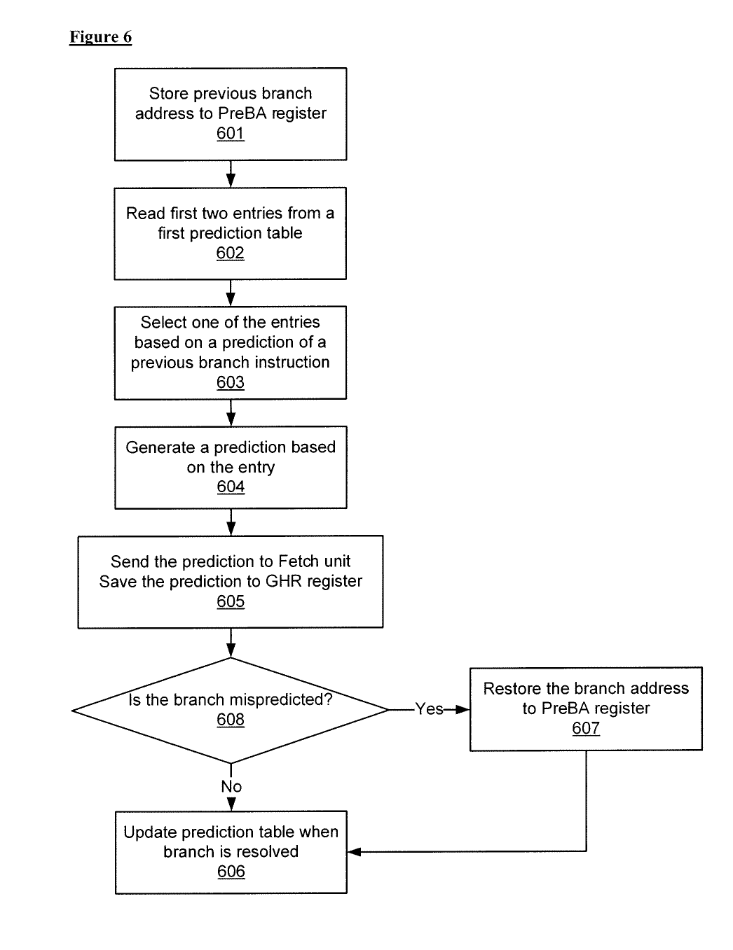

FIG. 6 is a block diagram of one embodiment of a validation system. In one embodiment, with reference to FIG. 6, the system comprises controller 600, signature generator 610, transaction information memory 611, conflict record logic 620, signature comparison logic 621, and write signatures memory 622. In one embodiment, controller 600 manages the information stored in transaction information memory 611 which contains information such as, for example, data structures associated with the transactions (as describe above with reference to FIG. 2). Signature generator 610 generates a read signature based on a read set and generates a write signature based on a write set.

In one embodiment, signature comparison logic 621 performs a comparison between two signatures (a read signature and a write signature) during a validation process. In one embodiment, signature comparison logic 621 comprises an intersection operator. The results from signature comparison logic 621 are sent to conflict record logic 620. In one embodiment, controller 600 in conjunction with conflict record logic 620 determines whether or not to update a local timestamp of a transaction during a validation process.

In one embodiment, when a transaction is ready to commit, controller 600 loads the write signature of the committing transaction to write signature memory 622. In one embodiment, controller 600 also loads other information associated with the committing transaction, for example, the commit time stamp, the write set, and the read set, for other validation mechanisms.

In one embodiment, controller 600 performs other operations related to management of transactions including creating of a new transaction, aborting a transaction, a rollback operation for a transaction, and safely terminating a transaction.

Although described herein as processing logic, each of the logic units can be implemented independently, separately or externally in different combinations.

Embodiments of the invention may be implemented in a variety of electronic devices and logic circuits. Furthermore, devices or circuits that include embodiments of the invention may be included within a variety of shared systems. Embodiments of the invention may also be included in other shared system topologies and architectures.

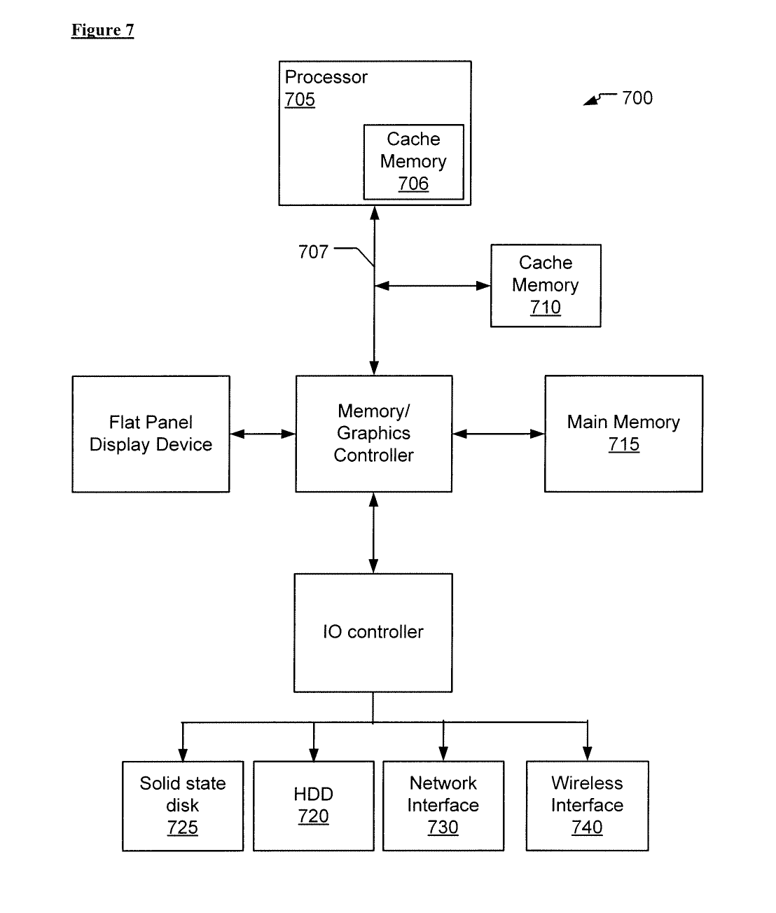

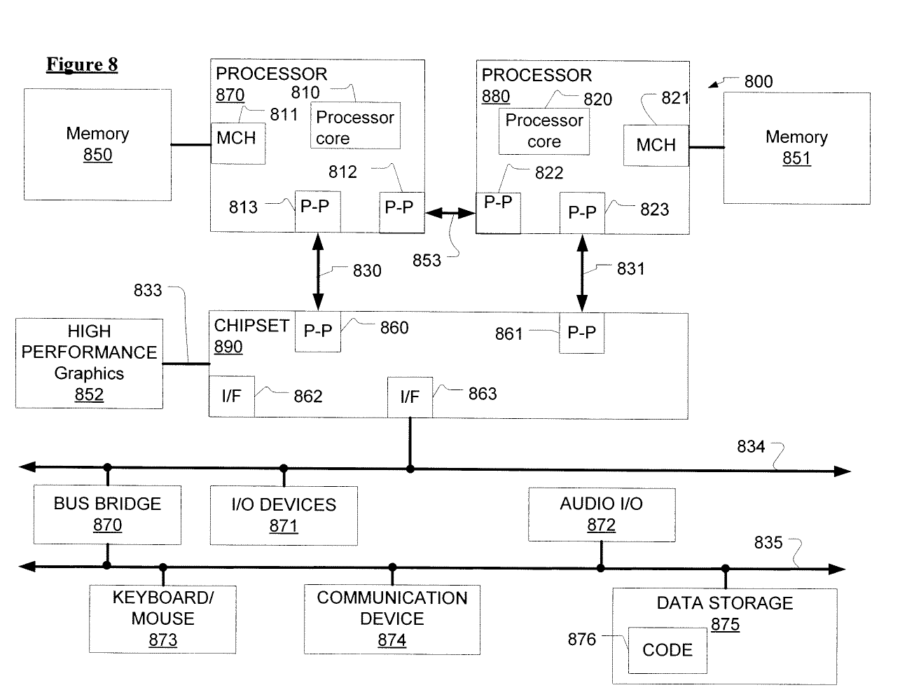

FIG. 7 illustrates a computer system for use with one embodiment of the present invention. A processor 705 accesses data from a level 1 (L1) cache memory 706, a level 2 (L2) cache memory 710, and main memory 715. In one embodiment, the cache memory 706 may be a multi-level cache memory comprise of an L1 cache together with other memory such as an L2 cache within a shared system memory hierarchy and cache memory 710 are the subsequent lower level cache memory such as an L3 cache or more multi-level cache. In one embodiment, the shared system may have the cache memory 710 as a shared cache for more than one processor core. The processor 705 may have any number of processing cores.

The main memory 715 may be implemented in various memory sources, such as dynamic random-access memory (DRAM), a hard disk drive (HDD) 720, a solid state disk 725 based on NVRAM technology, or a memory source located remotely from the shared system via network interface 730 or via wireless interface 740 containing various storage devices and technologies. The cache memory may be located either within the processor or in close proximity to the processor, such as on the processor's local bus 707. Furthermore, the cache memory may contain relatively fast memory cells, such as a six-transistor (6T) cell, or other memory cell of approximately equal or faster access speed.

Embodiments of the invention may be implemented within other devices within the system or distributed throughout the system in hardware, software, or some combination thereof. Other embodiments of the invention, however, may exist in other circuits, logic units, or devices within the system of FIG. 7. Furthermore, other embodiments of the invention may be distributed throughout several circuits, logic units, or devices illustrated in FIG. 7.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A method comprising:
comparing a read signature of a first transaction to a plurality of write signatures associated with a plurality of transactions; and
determining, based on a result of comparing the read signature, whether to update a local value of the first transaction to a commit value of a second transaction from the plurality of the transactions.

2. The method of claim 1, wherein the result indicates whether each transaction of the plurality of transactions is intersecting or non-intersecting with respect to the first transaction.

3. The method of claim 2, further comprising updating the local value of the first transaction to the commit value of the second transaction, wherein the second transaction is a non-intersecting transaction with the highest commit value.

4. The method of claim 2, further comprising updating the local value of the first transaction only if no intersecting transaction exists.

5. The method of claim 2, further comprising updating the local value of the first transaction to the commit value of the second transaction, wherein the commit value of the second transaction is a highest commit value that is lower than commit values of any intersecting transactions.

6. The method of claim 1, wherein comparing the read signature and determining whether to update the local value are performed in response to one or more occurrences of a read barrier or a write barrier in the first transaction.

7. The method of claim 1, further comprising:
increasing a global value when the second transaction enters its commit phase; and
setting the commit value of the second transaction to the global value.

8. The method of claim 1, wherein the plurality of the transactions are in a commit phase or a quiescence phase.

9. The method of claim 1, wherein the read signature of the first transaction comprises a first value indicative of a read set of the first transaction.

10. The method of claim 1, wherein a write signature of the second transaction comprises a second value indicative of a write set of the second transaction.

11. The method of claim 1, wherein the read signature is generated based on a read set of the first transaction using a hash function, wherein an intersection operation performs faster on the read signature than on the read set.

12. The method of claim 1, wherein a write signature of the second transaction is generated based on a write set of the second transaction using a hash function, wherein an intersection operation performs faster on the write signature than on the write set.

13. A method comprising:
increasing a global value;
setting a commit value of a first transaction to the global value;
switching the first transaction to a quiescence phase;
comparing the commit value of the first transaction to a local value of a second transaction that is from a plurality of active transactions, wherein the local value of the second transaction is updated one or more times before the second transaction enters its commit phase; and
determining the first transaction exits the quiescence phase if the commit value of the first transaction is lower than all local values of the plurality of transactions.

14. The method of claim 13, further comprising validating a read set of a first transaction.

15. The method of claim 13, further comprising publishing the commit value, a write set, and a write signature of the first transaction.

16. An article of manufacture comprising a shared readable storage medium including data storing instructions thereon that, when accessed by a machine, cause the machine to perform a method comprising:
comparing a read signature of a first transaction to a plurality of write signatures associated with a plurality of transactions; and
determining, based on a result of comparing the read signature, whether to update a local value of the first transaction to a commit value of a second transaction from the plurality of the transactions.

17. The article of manufacture of claim 16, wherein the result indicates whether each transaction of the plurality of transactions is intersecting or non-intersecting with respect to the first transaction.

18. The article of manufacture of claim 17, wherein the method further comprising updating the local value of the first transaction to the commit value of the second transaction, wherein the second transaction is a non-intersecting transaction with the highest commit value.

19. The article of manufacture of claim 17, wherein the method further comprising updating the local value of the first transaction only if no intersecting transaction exists.

20. The article of manufacture of claim 17, wherein the method further comprising updating the local value of the first transaction to the commit value of the second transaction, wherein the commit value of the second transaction is a highest commit value that is lower than commit values of any intersecting transactions.

21. The article of manufacture of claim 16, wherein comparing the read signature and determining whether to update the local value are performed in response to one or more occurrences of a read barrier or a write barrier in the first transaction.

22. The article of manufacture of claim 16, wherein the method further comprising:
increasing a global value when the second transaction enters its commit phase; and
setting the commit value of the second transaction to the global value.

23. The article of manufacture of claim 16, wherein the plurality of the transactions are in a commit phase or a quiescence phase.

24. The article of manufacture of claim 16, wherein the read signature of the first transaction comprises a first value indicative of a read set of the first transaction.

25. The article of manufacture of claim 16, wherein a write signature of the second transaction comprises a second value indicative of a write set of the second transaction.

26. The article of manufacture of claim 16, wherein the read signature is generated based on a read set of the first transaction using a hash function, wherein an intersection operation performs faster on the read signature than on the read set.

27. The article of manufacture of claim 16, wherein a write signature of the second transaction is generated based on a write set of the second transaction using a hash function, wherein an intersection operation performs faster on the write signature than on the write set.

28. A system comprising:
a first memory to store a first data comprising a read signature and a local value of a first transaction;
a second memory to store a second data comprising write signatures and commit values of a plurality of transactions including a second transaction;
a initialization logic to initialize the first data and the second data;
a rollback logic to rollback the first transaction if the first transaction is aborted; and
a validation logic to compare the read signature of the first transaction to the write signatures of the plurality of transactions and to determine whether to update the local value of the first transaction to a commit value of the second transaction.

29. The system of claim 28, wherein a result of comparing the read signature to the write signatures of the plurality of transactions indicates whether each transaction of the plurality of transactions is intersecting or non-intersecting with respect to the first transaction.

30. The system of claim 29, wherein the validation logic is operable to update the local value of the first transaction to the commit value of the second transaction, wherein the second transaction is a non-intersecting transaction with a highest commit value.

31. The system of claim 29, wherein the validation logic is operable to update the local value of the first transaction only if no intersecting transaction exists.

32. The system of claim 29, wherein the validation logic is operable to update the local value of the first transaction to the commit value of the second transaction, wherein the commit value of the second transaction is a highest commit value that is lower than commit values of any intersecting transactions.

33. The system of claim 28, wherein the validation logic is operable to compare the read signatures and determine whether to update the local value in response to one or more occurrences of a read barrier or a write barrier in the first transaction.

34. The system of claim 28, further comprising a counter to store a global value, wherein the validation logic is operable to increase the global value when the second transaction enters its commit phase and to set the commit value of the second transaction to the global value.

35. The system of claim 28, wherein the plurality of the transactions are in a commit phase or a quiescence phase.

36. The system of claim 28, wherein the read signature of the first transaction comprises a first value indicative of a read set of the first transaction.

37. The system of claim 28, wherein a write signature of the second transaction comprises a second value indicative of a write set of the second transaction.

38. The system of claim 28, wherein the first data further comprising a read set of the first transaction, the read signature is generated based on the read set of the first transaction using a hash function, wherein an intersection operation performs faster on the read signature than on the read set.

39. The system of claim 28, wherein the second data further comprising a write set of the second transaction, wherein a write signature of the second transaction is generated based on the write set of the second transaction using a hash function, wherein an intersection operation performs faster on the write signature than on the write set.

40. The system of claim 28, wherein the first memory and the second memory are the same.
